(19) United States
(12) Patent Application Publication
(10) Pub. No.: US 2012/0136608 A1
(43) Pub. Date: May 31, 2012

(54) TEST TABLE GENERATING DEVICE AND METHOD OF GENERATING TEST TABLE

(75) Inventors: Mitsunobu YOSHINAGA, Tokyo (JP); Shinichiro TSUDAKA, Tokyo (JP); Masayo NAKAGAWA, Tokyo (JP)

(73) Assignee: MITSUBISHI ELECTRIC CORPORATION, Chiyoda-ku (JP)

(21) Appl. No.: 13/155,665

(22) Filed: Jun. 8, 2011

(30) Foreign Application Priority Data
Nov. 25, 2010 (JP) 2010-262408

(51) Int. Cl. G06F 19/00

(52) U.S. Cl. 702/108

(57) ABSTRACT

A test table generating device includes a unit group input part, an upstream book analyzing part, a unit characteristic acquiring part, a unit characteristic matching part, and a test table generating section. The upstream book analyzing part analyzes an upstream book about a target unit designated by the unit group input part. The unit characteristic acquiring part acquires the unit characteristics of the target unit based on a result of the analysis. The unit characteristic matching part performs matching of the unit characteristics of the target unit, and specifies a similar unit having the same unit characteristics as those of the target unit. The test table generating section acquires a test table about the similar unit, and generates a test table about the target unit based on the acquired test table.

### BACKGROUND OF THE INVENTION

1. Field of the Invention

The present invention relates to a test table generating device for generating a test table showing a correlation between an input value and an output value, and which is used to determine the acceptance or rejection of a logic diagram when the logic diagram representing the substance of supervisory control of a unit in a supervisory control system is tested. The present invention also relates to a method of generating the test table.

2. Description of the Background Art

A supervisory control system is such a system that provides an operator/observer with information given from units to be monitored such as sensors of various types including a temperature sensor, a pressure sensor, and a position sensor. The supervisory control system also controls units of various types including a motor, a valve, a switch, and an oil hydraulic unit in response to an operation by the operator/observer. The supervisory control system is used in a wide range of fields including power-generating plants, chemical plants, power receiving and distributing facilities, and water supply and sewerage systems.

A typical supervisory control system is such that it includes a plurality of modules responsible for respective processes such as transmission and reception of signals to and from a unit targeted for supervisory control. These modules are coupled through a communication path to perform various processes.

In many cases, the substance of a process performed in each module of a supervisory control system is represented by an oriented graph such as a circuit diagram in which directions of input and output of signals are indicated by arrows. More specifically, the substance of a process performed in each module is expressed by a combination of nodes representing signal processes (hereinafter also called as “arithmetic elements”), and a link connecting the nodes and showing a flow of the signals (hereinafter also called “signal line”). The substance of a process in a module was formerly realized fixedly in a hardware circuit. In recent years, however, in consideration of flexibility and cost performance, it has been implemented as a program related to a digital calculator in many cases, so that the digital calculator can simulate the operation of the process before the process is performed.

Standards for a programming language that expresses the substance of a process by arithmetic elements and a signal line include the international standard IEC 61131-3, for example. The arithmetic elements are described in an FBD (function block diagram) that conforms to the international standard IEC 61131-3, and the substance of the process expressed by a combination of the arithmetic elements and a signal line is described in a diagram called a logic diagram.

A trend of recent times toward a larger scale of a program has made it difficult to extract test items properly from the program. This phenomenon also applies to a test to determine if a logic diagram representing supervisory control of a supervisory control system is correct or not. More specifically, a test table should be created before a test on a logic diagram is conducted. The test table contains an input value and an output value (expected value) used to determine the acceptance or rejection of the logic diagram targeted for the test, test items, and others. Moreover, a test should be conducted for each of a large number of input and output signals. This means that a large number of tests should be conducted, resulting in the enormous contents of the test table.

Nevertheless, a person such as a designer creates a test table manually based for example on his experience by using an upstream book created in the design stage of a supervisory control system and a logic diagram. This results in a fear of an error or omission as well as a longer time required for generation of a test table. Further, generation of a test table requires know-how to extract items and to determine the order of tests, making it quite difficult to automatically create a test table simply from an upstream book and a logic diagram. So, it has been a problem to be solved to create a test table efficiently that corresponds to a logic diagram of a supervisory control system when the logic diagram is tested.

An example of a technique of solving the problem is disclosed in patent literature 1 (Japanese Patent Application Laid-Open No. 2000-331056). The technique disclosed in patent literature 1 automatically creates a test table used for a logic diagram by using a model of a test table. Patent literature 1 discloses an electronic document generating device including: pattern matching means for changing a logic diagram to be tested and basic logic diagrams to organized calculation programs, and performing pattern matching thereof; test table retrieving means for retrieving a test table that corresponds to a basic logic diagram determined as a matching diagram; signal extracting means for making a correlation between a signal in the logic diagram to be tested and that in the basic logic diagram, and extracting the signals; and test table filling means for making the signal in the logic diagram to be tested take the place of the signal in the basic logic diagram in the test table.

The electronic document generating device disclosed in patent literature 1 performs matching of a target logic diagram and basic logic diagrams, and creates a test table for the target logic diagram by using a basic logic diagram that is determined to match the target logic diagram as a result of the comparison. This technique however requires creation or preparation of model test tables that are corresponding in number to basic logic diagrams. This means that a large number of test tables should be created or prepared in response to an increasing number of basic logic diagrams. Generation or preparation of a large number of test tables requires much time and effort.

### SUMMARY OF THE INVENTION

The present invention has been made to solve the aforementioned problems. It is an object of the present invention to provide a technique capable of generating a test table about a desired unit automatically without the need of creating or preparing such a test table separately.

The present invention is directed to a test table generating device for generating a test table showing a correlation between an input value and an output value, and which is used to determine the acceptance or rejection of a logic diagram when the logic diagram representing the substance of supervisory control of each of units in a supervisory control system is tested. The test table generating device includes a unit group input part, an upstream book analyzing part, a unit characteristic acquiring part, a unit characteristic matching part, and a test table generating section. The unit group input part designates a target unit which is one of the units, and which is to be targeted for generation of a test table. The upstream book analyzing part retrieves an upstream book about the target unit from an upstream book containing information about the units, and analyzes the retrieved upstream book. The unit characteristic acquiring part acquires the unit characteristics of the target unit based on a result of the analysis made by the upstream book analyzing part. The unit characteristic matching part performs matching of the unit characteristics of the target unit acquired by the unit characteristic acquiring part, and specifies a similar unit having the same unit characteristics as those of the target unit. The test table generating section acquires a test table about the similar unit, and generates the test table about the target unit based on the acquired test table.

A similar unit having the same unit characteristics as those of a target unit is specified, and a test table about the target unit is generated automatically by using a test table about the specified similar unit as a model. Thus, the test table about the target unit can be generated automatically without the need of creating or preparing such a test table separately, thereby saving time and effort required to create the test table.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows the structure of a test table generating device of a first preferred embodiment of the present invention;

FIG. 2 shows the structure of a typical supervisory control system;

FIG. 3 shows a systematic diagram;

FIG. 4 shows a unit specification list;

FIG. 5 shows a logic diagram about a similar unit;

FIG. 6 shows a test table used in a test on the logic diagram about the similar unit;

FIG. 7 is a flow diagram for explaining an operation by a similar unit searching section;

FIG. 8 is a flow diagram for explaining an operation by a test table generating section;

FIG. 9 shows a logic diagram about a target unit of the first preferred embodiment;

FIG. 10 shows a test table generated by a test table difference reflecting part;

FIG. 11 shows a logic diagram about a target unit of a second preferred embodiment of the present invention;

FIG. 12 is a flow diagram for explaining an operation by a test table generating section;

FIG. 13 shows a test table generated by a test table difference reflecting part; and

FIG. 14 shows the structure of a test table generating device of a third preferred embodiment of the present invention.

### DESCRIPTION OF THE PREFERRED EMBODIMENTS

### First Preferred Embodiment

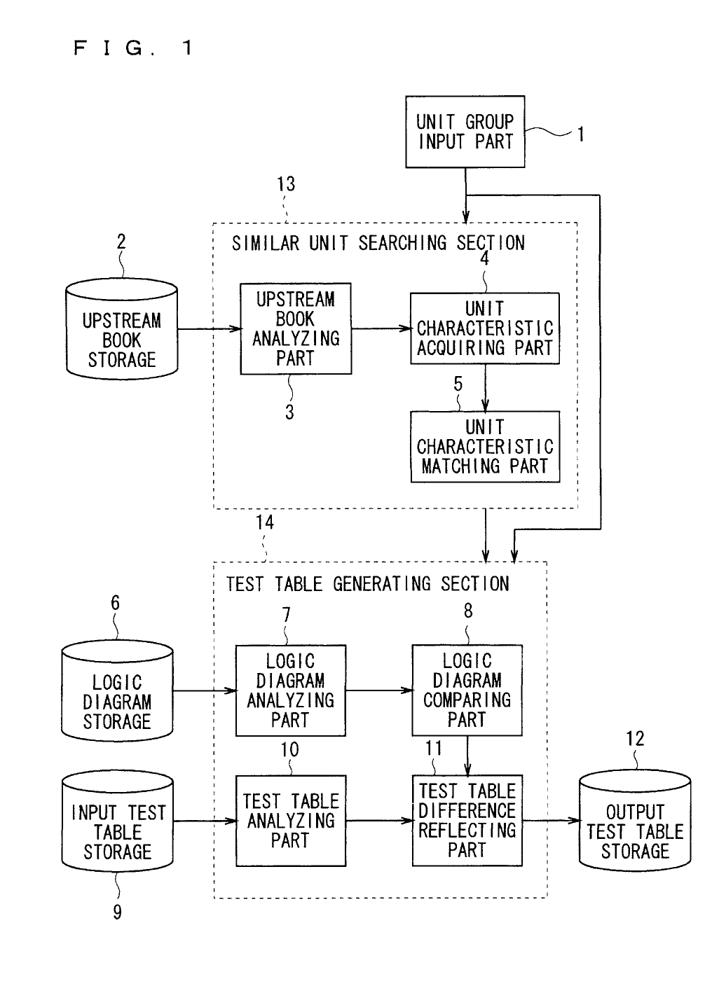

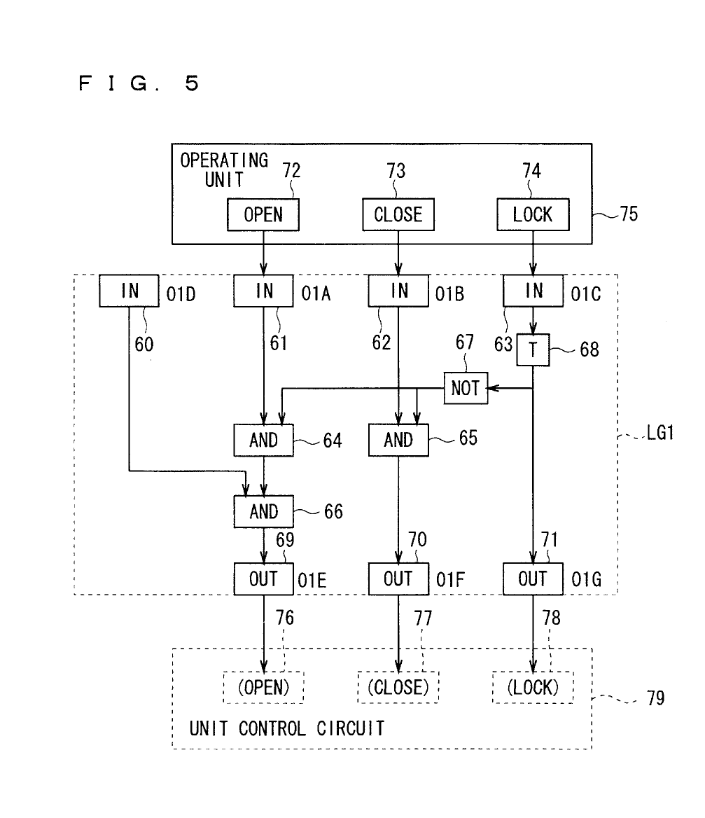

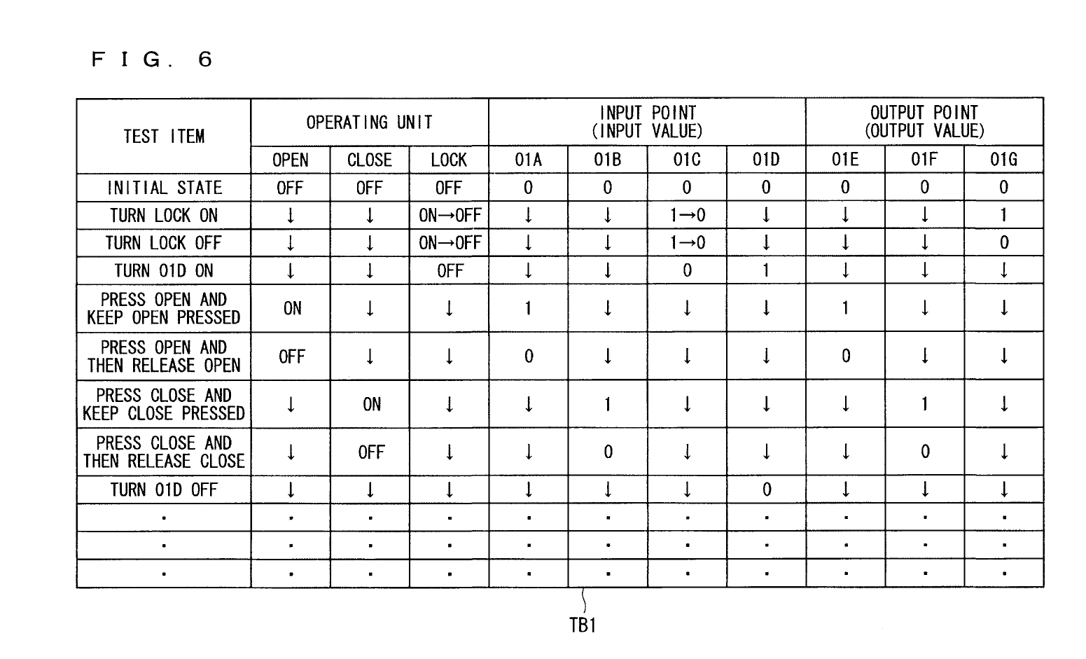

FIG. 1 shows the structure of a test table generating device of a first preferred embodiment of the present invention. In the first preferred embodiment, the substance of supervisory control of a unit in a supervisory control system is represented by a logic diagram. The test table generating device of the first preferred embodiment generates a test table showing a correlation between an input value and an output value (expected value), and which is used to determine the acceptance or rejection of such a logic diagram when the logic diagram is tested. A logic diagram representing the substance of supervisory control of a unit is shown in FIG. 5 and others. A test table used to determine the acceptance or rejection of the logic diagram is shown in FIG. 6 and others. The logic diagram and the test table are described in detail later.

In the test table generating device and the method of generating the test table of the first preferred embodiment, a test table about a desired unit is automatically generated based on a test table prepared in advance. The test table generating device of the first preferred embodiment is described in detail below. In the description given below, a plurality of units in a supervisory control system targeted for supervisory control may also be called “plurality of units” simply.

As shown in FIG. 1, the test table generating device of the first preferred embodiment includes: a unit group input part 1; an upstream book storage 2 in which an upstream book containing information about a plurality of units is stored; an upstream book analyzing part 3; a unit characteristic acquiring part 4; a unit characteristic matching part 5; a logic diagram storage 6 in which logic diagrams about a plurality of units are stored; a logic diagram analyzing part 7; a logic diagram comparing part 8; an input test table storage 9 in which a plurality of test tables is stored; a test table analyzing part 10; a test table difference reflecting part 11; and an output test table storage 12.

The unit group input part 1 accepts an operation from a person who is to create a test table. Then, in response to this operation, the unit group input part 1 designates a unit or a group of units targeted for generation of a test table as a target unit or a target group of target units that are some of the plurality of units. The unit group input part 1 outputs information indicating the target unit to a similar unit searching section 13 and to a test table generating section 14.

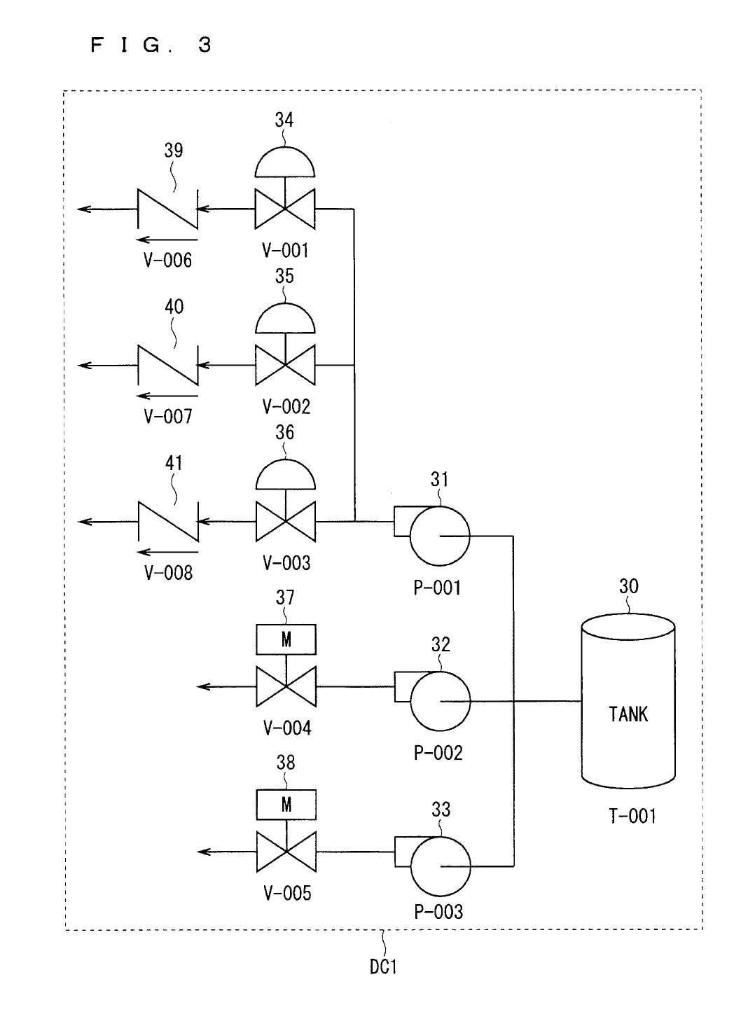

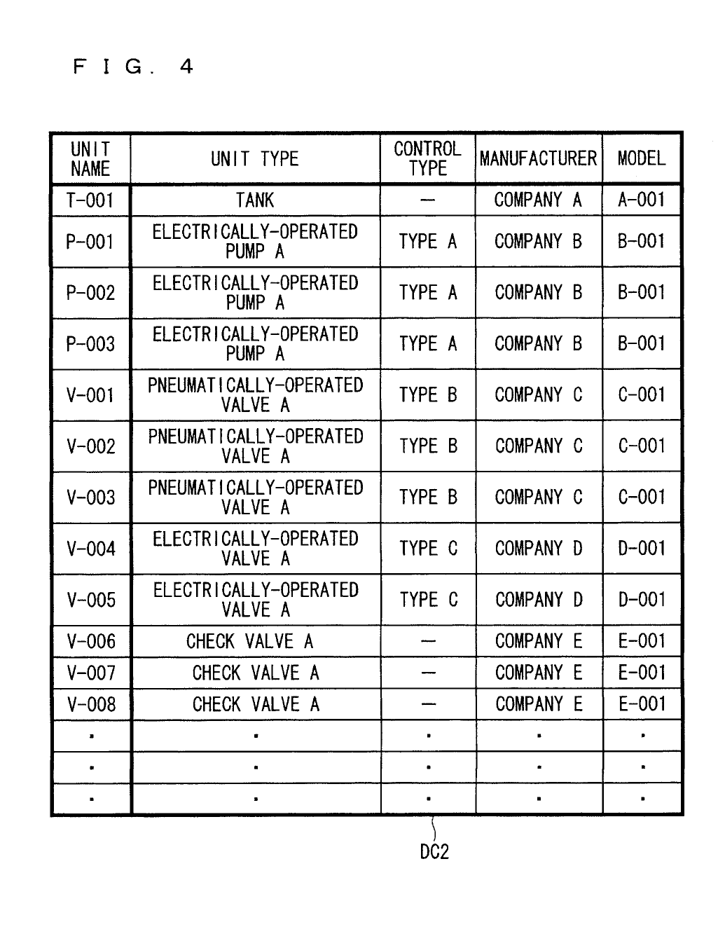

The upstream book analyzing part 3 retrieves an upstream book about the target unit from the upstream book stored in the upstream book storage 2, and analyzes the retrieved upstream book. The upstream book contains information created in the design stage of the supervisory control system. The upstream book of the first preferred embodiment contains information shown in FIGS. 3 and 4 described later. The unit characteristic acquiring part 4 acquires the unit characteristics of the target unit based on a result of the analysis made by the upstream book analyzing part 3. The unit characteristic matching part 5 performs matching of the unit characteristics of the target unit acquired by the unit characteristic acquiring part 4, and specifies a similar unit having unit characteristics that are the same as (similar to) those of the target unit.

The similar unit searching section 13 includes the upstream book analyzing part 3, the unit characteristic acquiring part 4, and the unit characteristic matching part 5. So, the similar unit searching section 13 specifies (searches for) a similar unit having unit characteristics similar to those of the target unit designated by the unit group input part 1. The similar unit searching section 13 outputs information for specifying the similar unit to the test table generating section 14.

The logic diagram analyzing part 7 retrieves a logic diagram about the similar unit specified by the similar unit searching section 13 and a logic diagram about the target unit from the logic diagrams stored in the logic diagram storage 6, and analyzes the retrieved logic diagrams. The logic diagram comparing part 8 extracts information about a difference between the logic diagrams about the similar unit and the target unit by comparing results of the analyses made by the logic diagram analyzing part 7 (namely, based on the results of the analyses made by the logic diagram analyzing part 7).

The test table analyzing part 10 retrieves a test table as a model about the similar unit specified by the similar unit searching section 13 from the test tables stored in the input test table storage 9, and analyzes the retrieved test table. The test table difference reflecting part 11 causes a result of the analysis of the test table retrieved by the test table analyzing part 10, and the information about a difference extracted by the logic diagram comparing part 8 to be reflected in the retrieved test table, thereby generating a test table about the target unit. The generated test table about the target unit is stored into the output test table storage 12.

The test table generating section 14 includes the logic diagram analyzing part 7, the logic diagram comparing part 8, the test table analyzing part 10, and the test table difference reflecting part 11. So, the test table generating section 14 generates a test table about a target unit based on a test table about a similar unit.

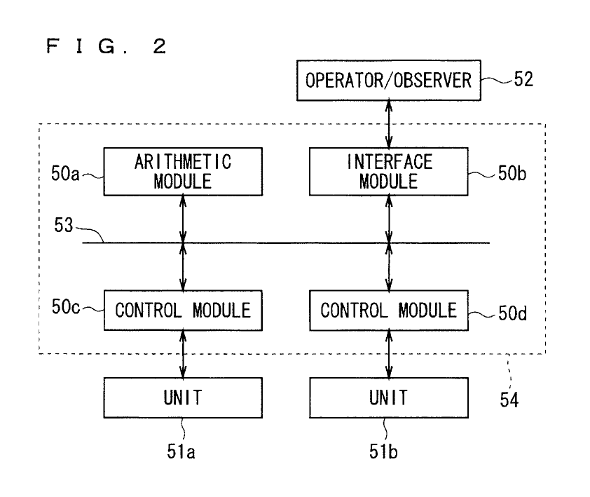

FIG. 2 shows the structure of a typical supervisory control system 54. The supervisory control system 54 includes four modules 50 coupled through a communication path 53. The four modules 50 transmit and receive signals to and from each other through the communication path 53.

The four modules 50 are constructed of an arithmetic module 50a, an interface module 50b, and control modules 50c and 50d. The control modules 50c and 50d control units 51a and 51b respectively to be targeted for supervisory control (in the below, the units 51a and 51b may also be called “units 51” if distinction therebetween is not necessary). The interface module 50b transmits and receives information to and from an operator/observer 52. The arithmetic module 50a performs calculation and others based on information received from the other three modules 50.

FIG. 3 shows a systematic diagram DC1 stored as the upstream book in the upstream book storage 2. To be specific, the upstream book of the first preferred embodiment contains the systematic diagram DC1 that shows interconnections between the units 51 (FIG. 2) in the supervisory control system 54 targeted for supervisory control.

In the example shown in FIG. 3, the supervisory control system 54 includes a tank 30, three electrically-operated pumps 31, 32 and 33, three pneumatically-operated valves 34, 35 and 36, two electrically-operated valves 37 and 38, and three check valves 39, 40 and 41 each of which corresponds to the unit 51, and a pipe for connecting the units 51. More specifically, the tank 30 is connected to the electrically-operated valves 37 and 38 through the electrically-operated pumps 32 and 33 respectively. The tank 30 is also connected to the electrically-operated pump 31. The electrically-operated pump 31 is connected to the check valves 39, 40 and 41 through the pneumatically-operated valves 34, 35 and 36 respectively. The units 51 are given their names such as “T-001” and “P-001” specific to the units 51.

FIG. 4 shows a unit specification list DC 2 stored as the upstream book in the upstream book storage 2. That is, the upstream book of the first preferred embodiment contains not only the systematic diagram DC1 but also contains the unit specification list DC2 that shows the respective unit specifications of the plurality of units 51 shown in the systematic diagram DC1.

In the example shown in FIG. 4, the unit specifications of the plurality of units 51 shown in the unit specification list DC2 include “UNIT NAME,” “UNIT TYPE” indicating the types of the units 51, “CONTROL TYPE” indicating the types of controls (operations) of the units 51, “MANUFACTURER” indicating the manufacturers of the units 51, and “MODEL” of the units 51. “CONTROL TYPE” includes controls where an electrically-operated pump is operated only with “ON” and “OFF” buttons, and where an electrically-operated pump is operated with a “locking” button in addition to “ON” and “OFF” buttons, for example. These controls are related to “TYPE A” and “TYPE B,” for example. “CONTROL TYPE” shown in the unit specification list DC2 includes a symbol “-” which means that control is not intended.

FIG. 5 is an example of a logic diagram LG1 stored in the logic diagram storage 6. The logic diagram LG1 shows the substance of supervisory control (control logic) of the unit 51a that is made by the control module 50c (FIG. 2) in response to input signals from the interface module 50b and the control module 50d.

An arithmetic element 60 indicates an input point in the control module 50c that receives a signal from the control module 50d for controlling the unit 51b (FIG. 2) different from the unit 51a. Arithmetic elements 61, 62 and 63 each indicate an input point in the control module 50c that receives a signal from the interface module 50b (FIG. 2). The interface module 50b corresponds to an operating unit 75 in FIG. 5. An input signal given from the interface module 50b to the control module 50c changes in response to an operation by the operator/observer 52. The operating unit 75 has an open button 72 with which an input signal responsive to an operation for “OPEN” is given to the arithmetic element 61, a close button 73 with which an input signal responsive to an operation for “CLOSE” is given to the arithmetic element 62, and a locking button 74 with which an input signal responsive to an operation for “LOCK” is given to the arithmetic element 63.

Arithmetic elements 69, 70 and 71 each indicate an output point in the control module 50c that outputs a signal to a unit control circuit 79 for controlling the unit 51a (FIG. 2). An actual situation is that the unit control circuit 79 has unit controllers 76, 77 and 78 to which circuits responsible for controls (OPEN, CLOSE and LOCK) of units such as the unit 51a are assigned. In FIG. 2, however, the specific structures of these circuits are not shown.

In order to facilitate the understanding of description, the arithmetic elements 60 to 63 may also be called “input points 60 to 63” respectively, and the arithmetic elements 69 to 71 may also be called “output points 69 to 71” respectively. The input points 60 to 63 and the output points 69 to 71 are given the names of corresponding signals such as “O1D” and “01A” on their right sides as their attribute information.

The arithmetic elements 64, 65 and 66 are each an element that outputs “1” only if inputs are all “1” while outputting “0” in other cases, namely an element that performs a logical AND operation of a signal. The arithmetic element 67 is an element that outputs “1” if an input is “0” while outputting “0” if an input is “1,” namely an element that performs a NOT operation of a signal. The arithmetic element 68 is an element that changes its output from “0” to “1” or from “1” to “0” each time its input changes from “0” to “1,” namely an element that has a function of a single-input flip-flop. In the description given below, the arithmetic elements 64 to 66 may also be called “logical AND elements 64 to 66” respectively, the arithmetic element 67 may also be called “NOT element 67,” and the arithmetic element 68 may also be called “single-input flip-flop element 68.”

A signal from the input point 63 is divided into two signals after passing through the single-input flip-flop element 68. One signal generated after the division is given to the output point 71, while the other signal is further divided into two signals after passing through the NOT element 67. The two signals having passed through the NOT element 67 are given to the logical AND elements 64 and 65. A signal from the input point 62 is given to the logical AND element 65. The logical AND element 65 computes the logical AND of the signals from the input point 62 and from the NOT element 67, and outputs a resultant signal to the output point 70. A signal from the input point 61 is given to the logical AND element 64. The logical AND element 64 computes the logical AND of the signals from the input point 61 and from the NOT element 67, and outputs a resultant signal to the logical AND element 66. A signal from the input point 60 is given to the logical AND element 66. The logical AND element 66 computes the logical AND of the signals from the input point 60 and from the logical AND element 64, and outputs a resultant signal to the output point 69. In the example shown in FIG. 5, the plurality of arithmetic elements 60 to 71 are connected through the signal line such that the aforementioned signal inputs and outputs are realized between the arithmetic elements 60 to 71.

FIG. 6 shows part of a test table TB1 used in a test to determine if the logic diagram LG1, namely the substance of the supervisory control in the control module 50cis correct or not. As shown in FIG. 6, the test table TB1 contains correlations between input values and output values (expected values) used to determine the acceptance or rejection of the logic diagram LG1. More specifically, the test table TB1 mainly contains from the left of FIG. 6 test items, input operations through the operating unit 75, input values (setting values) of input signals to be set, and output values (confirmed values) to be confirmed as the outputs of output signals. In the test table TB1 shown in FIG. 6, “01A,” “01B,” and “01C” that are parts of “INPUT POINT” correspond respectively to “OPEN,” “CLOSE,” and “LOCK” that are parts of “OPERATING UNIT.”

Tests shown in the test table TB1 are conducted in a direction from the top row to the bottom row. A symbol “↓” appearing in frames of the test table TB1 shows that these frames are in the same states as the corresponding frames of previous test items. As an example, according to the description of the test table TB1, “OPEN” of “OPERATING UNIT” should be switched from OFF to ON when the test item “PRESS OPEN AND KEEP OPEN PRESSED” is started. In this case, in a test on the logic diagram LG1, the open button 72 of the operating unit 75 intended for an opening operation is pressed and is kept pressed according to the description of the test table TB1. It is confirmed as a result of the test that the input signal “01A” and the output signal “01E” are changed to “1,” while the other signals are kept “0.”

Units in a supervisory control system targeted for control processes generally have similar unit characteristics, and these units are generally subjected to similar supervisory control processes. Similarity of the supervisory control processes results in similarity of logic diagrams and test tables.

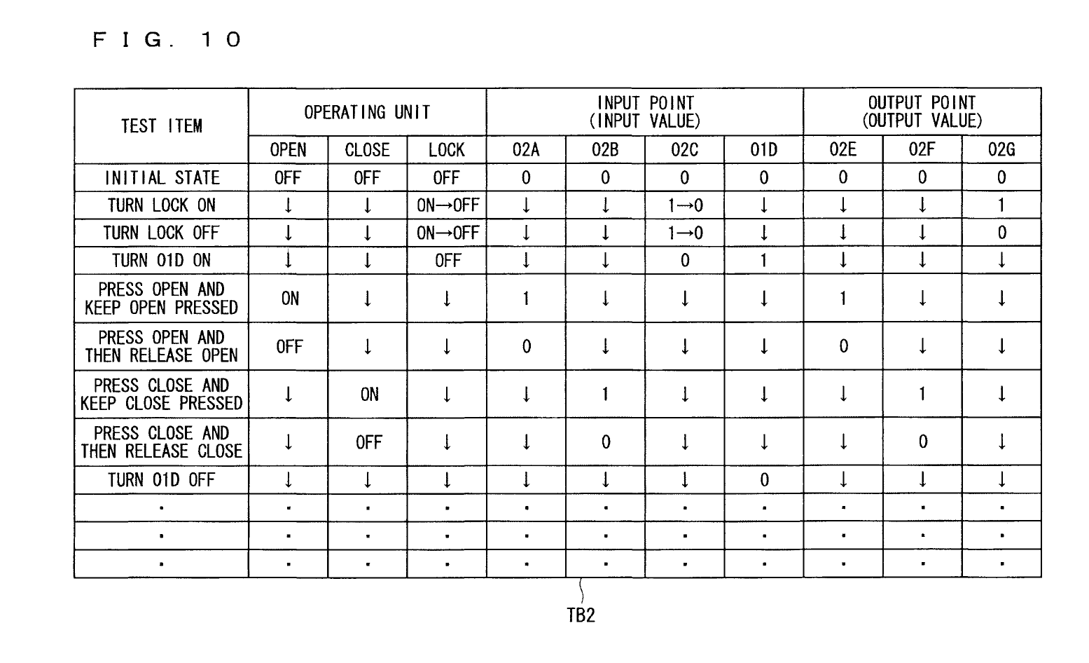

So, in the test table generating device and the method of generating the test table of the first preferred embodiment, the upstream book is analyzed and unit characteristics are subjected to matching. Then, a similar unit that is one of a plurality of units and similar to a target unit is specified, and an existing test table (FIG. 6) about the specified similar unit is used as a model to automatically generate a test table (FIG. 10) about the target unit. This makes a task of creating a test table separately about the target unit unnecessary, so that the workload of a person such as a designer can be reduced. The operations of the test table generating device and the method of generating the test table of the first preferred embodiment are described in detail below.

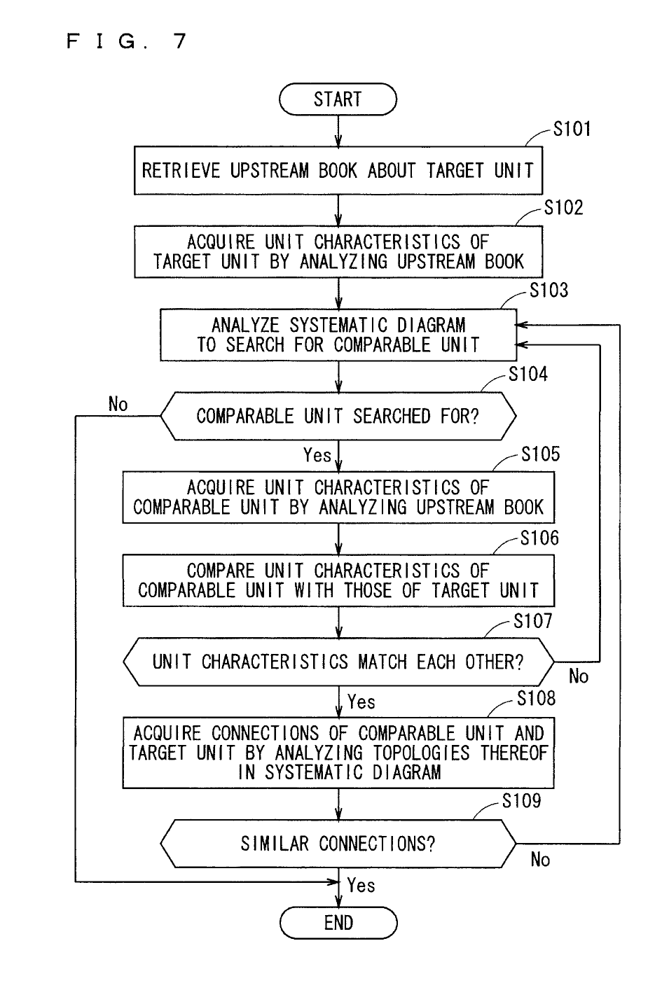

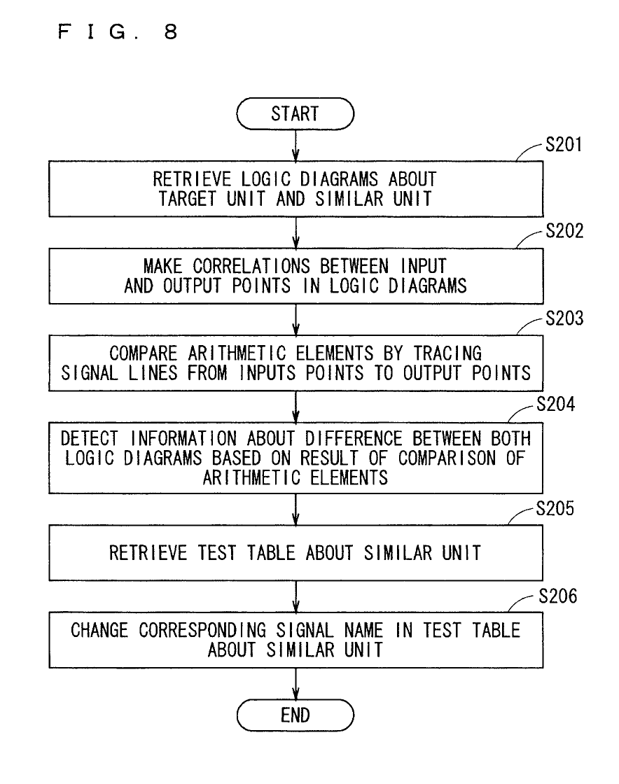

FIG. 7 is a flow diagram for explaining an operation by the similar unit searching section 13 (FIG. 1) to specify a unit similar to a target unit. FIG. 8 is a flow diagram for explaining an operation by the test table generating section 14 (FIG. 1) to generate a test table about a target unit based on a test table about a similar unit. The description below specifically explains by referring to FIGS. 7, 8 and other figures how the test table generating device of the first preferred embodiment operates when the unit group input part 1 designates a unit “V-005” shown in FIG. 4 as a target unit.

The operation by the similar unit searching section 13 to specify a unit similar to the target unit “V-005” is described first by using FIG. 7.

In step S101, the upstream book analyzing part 3 retrieves an upstream book about the target unit “V-005” designated by the unit group input part 1 from the upstream book storage 2. More specifically, the upstream book analyzing part 3 retrieves the systematic diagram DC1 shown in FIG. 3, and the unit specification list DC2 shown in FIG. 4 as the upstream book.

The upstream book analyzing part 3 analyzes the unit specification list DC2 (unit type and control type) in step S102, so that the unit characteristic acquiring part 4 acquires the unit characteristics (unit type and control type) of the target unit “V-005.” In the example shown in FIG. 4, the unit characteristic acquiring part 4 acquires “ELECTRICALLY-OPERATED VALVE A” and “TYPE C” as the unit type and the control type of the target unit “V-005” respectively.

In step S103, the upstream book analyzing part 3 analyzes the systematic diagram DC1 to search for a unit 51 comparable to the target unit “V-005” (hereinafter called “comparable unit”). Step S103 may be performed after steps S107 and S109 described later. In this case, step S103 is performed several times. A comparable unit to be searched for in step S103 changes each time step S103 is performed. In the first preferred embodiment, a comparable unit to be searched for in step S103 changes in the order named: “T-001,” “P-001,” “P-002,” “P-003,” “V-001,” “V-002,” “V-003,” “V-004,” “V-005,” “V-006,” “V-007,” and “V-008.”

The upstream book analyzing part 3 determines in step S104 if a comparable unit could be searched for in step S103. The flow goes to step S105 if a comparable unit could be searched for. If a comparable unit could not be searched for (if the unit “V-008” was already searched for in the case of the first preferred embodiment), the operation is finished.

Like in step S102, the upstream book analyzing part 3 analyzes the unit specification list DC2 (unit type and control type) in step S 105, so that the unit characteristic acquiring part 4 acquires the unit characteristics (unit type and control type) of the comparable unit. As an example, when step S105 is performed for the first time in the first preferred embodiment, the unit characteristic acquiring part 4 acquires the unit type and the control type of the unit “T-001,” namely “TANK” and “-.”

In step S106, the unit characteristic matching part 5 performs matching by comparing the unit type and the control type of the comparable unit with those of the target unit “V-005” to determine if they match each other. If the unit characteristic matching part 5 determines in step S107 that they match each other as a result of the matching, the flow goes to step S108. If the unit characteristic matching part 5 determines that they do not match each other, the flow returns to step S103.

As an example, if steps S106 and S107 are performed for the first time in the first preferred embodiment, the unit characteristic matching part 5 compares the unit type and the control type of the comparable unit “T-001” with those of the target unit “V-005.” The unit type and the control type of the unit “T-001” are “TANK” and “-” respectively, while the unit type and the control type of the target unit “V-005” are “ELECTRICALLY-OPERATED VALVE A” and “TYPE C” respectively. In this case, the unit characteristic matching part 5 determines that their unit types and control types do not match each other. So, the flow returns to step S103. Next, steps S103 to S107 are each performed several times. When the unit “V-004” (of a unit type “ELECTRICALLY-OPERATED VALVE A” and a control type “TYPE C”) becomes a comparable unit, the flow goes to step S108.

In step S108, the upstream book analyzing part 3 analyzes the respective topologies in the systematic diagram DC1 regarding the comparable unit determined as a matching unit in step S107, and the target unit. Then, based on results of the analyses, the unit characteristic acquiring part 4 acquires the respective unit characteristics (connections) of the comparable unit and the target unit.

The unit characteristic matching part 5 determines in step S109 if the respective connections of the comparable unit and the target unit “V-005” are similar to each other.

If the unit characteristic matching part 5 determines in step S109 that the comparable unit and the target unit have similar connections, the comparable unit becomes a similar unit, and the operation explained in FIG. 7 is finished. If the unit characteristic matching part 5 determines in step S109 that the comparable unit and the target unit do not have similar connections, the flow returns to step S103. In this case, the operation described above is repeated until a determination as to similarity of connections is made in step S109.

More specifically, the comparable unit “V-004” is placed downstream of the units “T-001” and “P-002,” while the target unit “V-005” is placed downstream of the units “T-001” and “P-003,” meaning that the comparable unit “V-004” and the target unit “V-005” are connected in parallel. Further, the unit “P-002” has the same unit characteristics (unit type and control type) as those of the unit “P-003.” In this case, the unit characteristic matching part 5 determines that the comparable unit “V-004” and the target unit “V-005” have similar connections. So, as a result of the operation by the similar unit searching section 13 explained in FIG. 7, the unit “V-004” is specified as a unit similar to the target unit “V-005.”

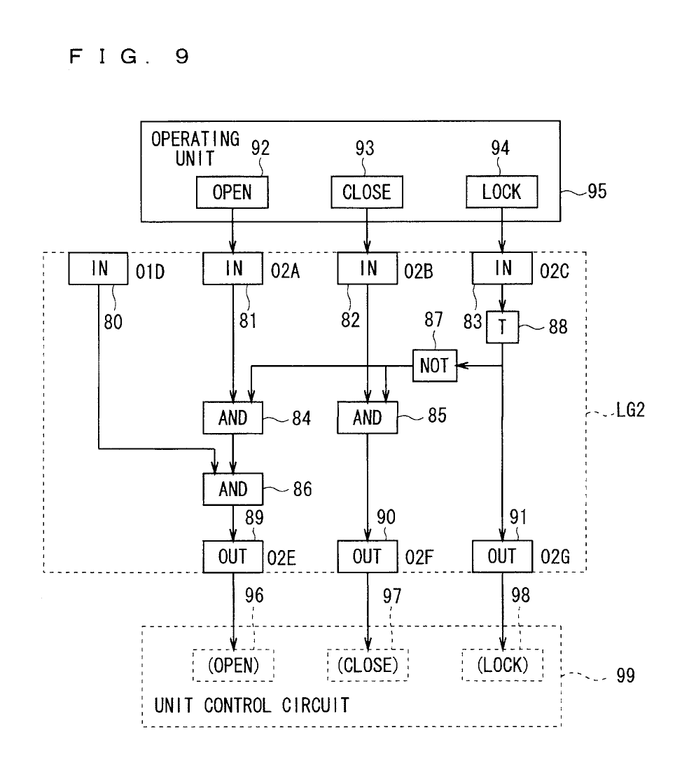

The operation by the test table generating section 14 to generate a test table about the target unit “V-005” based on a test table about the similar unit “V-004” is described next by using FIG. 8. The description given below is based on the assumption that the logic diagram LG1 shown in FIG. 5 is a logic diagram about the similar unit “V-004,” and the test table TB1 shown in FIG. 6 is a test table about the similar unit “V-004.” It is also assumed that a logic diagram shown in FIG. 9 is a logic diagram LG2 about the target unit “V-005.” It is further assumed that the logic diagrams LG1 and LG2 are stored in the logic diagram storage 6 (FIG. 1), and the test table TB1 is stored in the input test table storage 9 (FIG. 1).

In step S201, the logic diagram analyzing part 7 retrieves the logic diagram LG2 about the target unit “V-005” designated by the unit group input part 1, and the logic diagram LG1 about the similar unit “V-004” specified by the similar unit searching section 13 from the logic diagram storage 6.

The logic diagram analyzing part 7 makes correlations between input and output points in the logic diagram LG1, and input and output points in the logic diagram LG2 in step S202. More specifically, the logic diagram analyzing part 7 makes correlations between input points 61 (“01A”), 62 (“01B”), and 63 (“01C”) in the logic diagram LG1, and input points 81 (“02A”), 82 (“02B”), and 83 (“02C”) in the logic diagram LG2 based on the connection between the operating unit 75 and the input points 61 to 63, and the connection between an operating unit 95 and the input points 81 to 83. The logic diagram analyzing part 7 also makes a correlation between the remaining input point 60 (“01D”) in the logic diagram LG1, and a remaining input point 80 (“02D”) in the logic diagram LG2.

In step S202, the logic diagram analyzing part 7 also makes correlations between output points 69 (“01E”), 70 (“01F”), and 71 (“01G”) in the logic diagram LG1, and output points 89 (“02E”), 90 (“02F”), and 91 (“02G”) in the logic diagram LG2 based on the connection between the unit control circuit 79 and the output points 69 to 71, and the connection between a unit control circuit 99 and the output points 89 to 91.

In step S203, the logic diagram comparing part 8 compares arithmetic elements in the logic diagram LG1 and those in the logic diagram LG2 by tracing their signal lines from the correlated input points 60 to 63 and 80 to 83 to the correlated output points 69 to 71 and 89 to 91 respectively. The logic diagrams LG1 (FIG. 5) and LG2 (FIG. 9) do not differ from each other in terms of the types of arithmetic elements and the like. So, in the comparison between the logic diagrams LG1 and LG2, the signal lines are traced to the aforementioned output points while no difference of the arithmetic elements is detected.

The logic diagram comparing part 8 extracts two types of information about differences (here, information about differences in control logic and signal name) between the two logic diagrams LG1 and LG2 in step S204 based on a result of the comparison of the arithmetic elements.

As for the information about a difference in control logic that is one of the two types of information about differences, the logic diagram comparing part 8 searches for an arithmetic element except those correlated in step S203 as information about a difference in control logic. The logic diagrams LG1 and LG2 shown in FIGS. 5 and 9 respectively contain only those arithmetic elements correlated to each other in step S203. So, information about a difference in control logic is not detected as a result of the search for an arithmetic element except those correlated in step S203. A second preferred embodiment describes a case where there is a difference in control logic.

As for the information about a difference in signal name that is the other of the two types of information about differences, the logic diagram comparing part 8 searches for information about a difference between the signal names of the arithmetic elements correlated in step S203. As a result of the search for the information about a difference in signal name between the logic diagrams LG1 and LG2 shown in FIGS. 5 and 9 respectively by the logic diagram comparing part 8, the signal names “01A,” “01B,” “01C,” “01E,” “01F,” and “01G” in the logic diagram LG1, and the signal names “02A,” “02B,” “02C,” “02E,” “02F,” and “02G” in the logic diagram LG2 are detected as the information about a difference in signal name.

In step S205, the test table analyzing part 10 retrieves the test table TB1 (FIG. 6) about the similar unit “V-004” specified by the similar unit searching section 13 from the input test table storage 9.

FIG. 10 shows a test table TB2 about the target unit “V-005” generated after the test table difference reflecting part 11 performs step S206. In step S206, the test table difference reflecting part 11 causes the information about a difference (information about a difference in signal name) detected in step S204 to be reflected in the test table TB1 retrieved by the test table analyzing part 10, thereby generating the test table TB2 shown in FIG. 10. More specifically, the test table difference reflecting part 11 makes the signal names “02A,” “02B,” “02C,” “02E,” “02F,” and “02G” take the place of the signal names “01 A,” “01 B,” “01 C,” “01 E,” “01 F,” and “01 G” in the retrieved test table TB 1 respectively.

As a result, the test table difference reflecting part 11 generates the test table TB2 about the target unit “V-005.” Then, the test table difference reflecting part 11 stores the generated test table TB2 into the output test table storage 12.

In the aforementioned test table generating device and the method of generating the test table of the first preferred embodiment, a similar unit having the same unit characteristics as those of a target unit is specified. The test table TB1 about the specified similar unit is used as a model to automatically generate the test table TB2 about the target unit. This makes it unnecessary to create or prepare a test table about a desired unit separately as the test table about the desired unit can be generated automatically, thereby saving time and effort required to create the test table.

In terms of comparison from a conventional test table generating device, the conventional test table generating device can create a test table only if a logic diagram about a target unit and a logic diagram as a model completely match each other, resulting in poor efficiency in creating a test table. In contrast, in the test table generating device and the method of generating the test table of the first preferred embodiment, the test table TB2 about a target unit is generated by causing a difference between the logic diagrams LG2 and LG1 about the target unit and a similar unit respectively to be reflected. This means that the test table TB2 about the target unit can be generated even if the logic diagrams LG2 and LG1 do not mach each other completely, so that the test table generating device and the method of generating the test table to be provided exhibit excellent usability.

In the test table generating device and the method of generating the test table of the first preferred embodiment, the logic diagram analyzing part 7 makes correlations between input and output points in the logic diagram LG2 about a target unit, and input and output points in the logic diagram LG1 about a similar unit. Then, the logic diagram comparing part 8 compares the logic diagrams LG2 and LG1 by tracing their signal lines from one of the correlated input and output points (input points) to the other of the correlated input and output points (output points), thereby extracting information about a difference. So, information about a difference can be extracted precisely from logic diagrams with various types of connection patterns. In the description given above, the logic diagram comparing part 8 extracts information about a difference by tracing signal lines from input points to output points. The logic diagram comparing part 8 may alternatively extract information about a difference by tracing signal lines from output points to input points.

In the test table generating device and the method of generating the test table of the first preferred embodiment, the upstream book analyzing part 3 analyzes the systematic diagram DC1 that shows interconnections between the units 51 in the supervisory control system 54, and the unit characteristic acquiring part 4 acquires the unit characteristics of a target unit based on a result of the analysis. This allows a similar unit to be specified precisely, so that a more appropriate test table can be generated.

In the test table generating device and the method of generating the test table of the first preferred embodiment, the upstream book analyzing part 3 analyzes a unit type and a control type, and the unit characteristic acquiring part 4 acquires the unit characteristics of a target unit based on a result of the analysis. This allows a similar unit to be specified precisely, so that a more appropriate test table can be generated.

In the description given above, the test table generating device of the first preferred embodiment operates to generate a test table about the unit “V-005.” The test table generating device of the first preferred embodiment can also generate a test table about a unit 51 other than the unit “V-005” by operating in the same manner as it operates to generate a test table about the unit “V-005.”

While a test table is generated based on a very simple logic diagram such as that shown in FIG. 9 in the first preferred embodiment, a logic diagram is necessarily such a simple diagram. As an example, a larger scale of the operation of the module 50 makes it difficult to describe behavior in one logic diagram, so the behavior is generally described in a plurality of diagrams. In this case, connections between the diagrams may be stored for example by representing a signal from one diagram to a different diagram by a symbol, so the plurality of logic diagrams can be compared with one another.

In the first preferred embodiment, unit characteristics are described as those in the unit specification list DC2 (unit type and control type) and the systematic diagram DC1. Meanwhile, unit characteristics may be constructed only of a unit type and a control type, or may be constructed only of the systematic diagram DC1. In either case, a test table can be generated with a higher possibility, whereas a similar unit has a lower degree of similarity compared to those in the case of the first preferred embodiment.

Unit characteristics are not limited to three types of characteristics: a unit type; a control type; and the systematic diagram DC1. Further, if it is required to acquire unit characteristics from a book other than the systematic diagram DC1 or the unit specification list DC2, the upstream book analyzing part 3 is used to analyze such a book, so that unit characteristics can be acquired likewise.

### Second Preferred Embodiment

What are described in a second preferred embodiment of the present invention are the operation of a test table generating device and a method of generating the test table in the case of presence of a difference in control logic detected between a logic diagram about a target unit and a logic diagram about a similar unit in step S204 of the first preferred embodiment. Like in the preferred embodiment, it is assumed in the description given below that the unit group input part 1 designates the unit “V-005”, and the similar unit searching section 13 specifies the unit “V-004.”

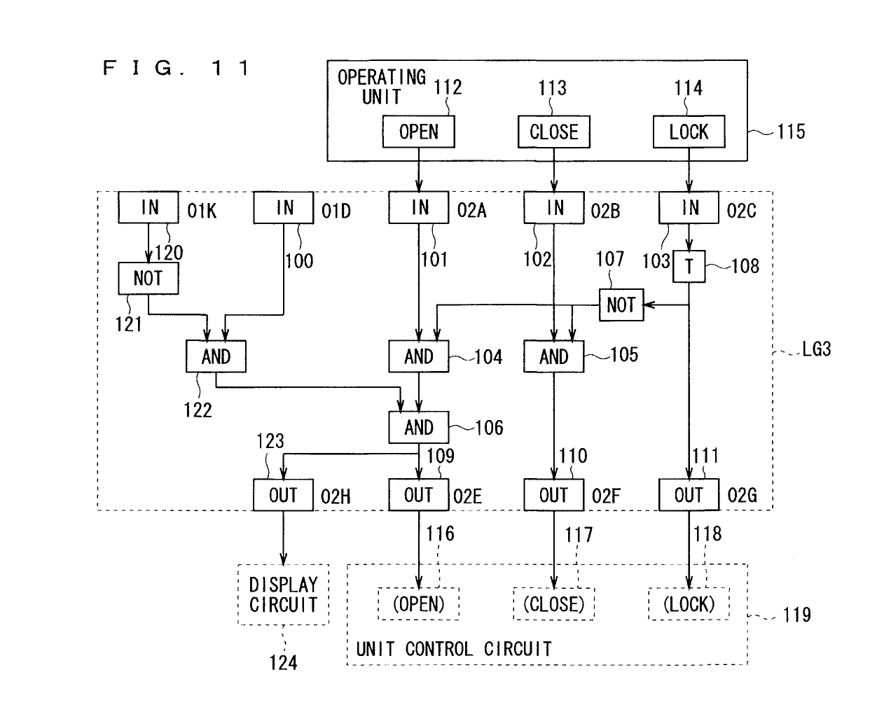

It is also assumed that a logic diagram about the target unit “V-005” of the second preferred embodiment is a logic diagram LG3 shown in FIG. 11. A control logic on the left side of the logic diagram LG3 shown in FIG. 11 differs both from the corresponding control logics of the logic diagram LG1 (FIG. 5) and the logic diagram LG2 (FIG. 9). In this case, the test table generating section 14 of the test table generating device operates in a manner slightly different from that described in the first preferred embodiment.

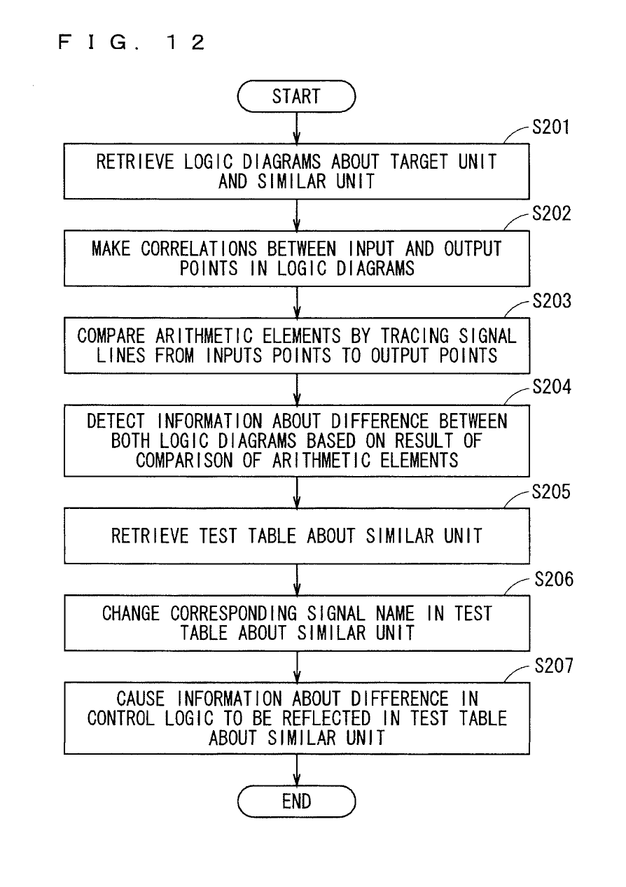

FIG. 12 is a flow diagram for explaining an operation by the test table generating device (test table generating section 14) performed when a logic diagram about a target unit differs from a logic diagram about a similar unit. The processes in steps S201 to S206 are substantially the same as those in the corresponding steps in the first preferred embodiment. A large difference from the first preferred embodiment is that the second preferred embodiment additionally performs step S207.

In step S201, the logic diagram analyzing part 7 retrieves the logic diagram LG3 about the target unit “V-005” designated by the unit group input part 1, and the logic diagram LG1 about the similar unit “V-004” specified by the similar unit searching section 13 from the logic diagram storage 6.

The logic diagram analyzing part 7 makes correlations between input and output points in the logic diagram LG1, and input and output points in the logic diagram LG3 in step S202. More specifically, the logic diagram analyzing part 7 makes correlations between input points 61 (“01A”), 62 (“01B”), and 63 (“01C”) in the logic diagram LG1, and input points 101 (“02A”), 102 (“02B”), and 103 (“02C”) in the logic diagram LG3 based on the connection between the operating unit 75 and the input points 61 to 63, and the connection between an operating unit 115 and the input points 101 to 103.

The logic diagram analyzing part 7 also makes correlations between output points 69 (“01E”), 70 (“01F”), and 71 (“01G”) in the logic diagram LG1, and output points 109 (“02E”), 110 (“02F”), and 111 (“02G”) in the logic diagram LG3 based on the connection between the unit control circuit 79 and the output points 69 to 71, and the connection between a unit control circuit 119 and the output points 109 to 111.

In step S203, the logic diagram comparing part 8 compares arithmetic elements in the logic diagram LG1 and those in the logic diagram LG3 by tracing their signal lines from the correlated input points 61 to 63 and 101 to 103 to the correlated output points 69 to 71 and 109 to 111 respectively. The logic diagrams LG1 (FIG. 5) and LG3 (FIG. 11) do not differ from each other in terms of the types of arithmetic elements and the like. So, in the comparison between the logic diagrams LG1 and LG3, the signal lines are traced to the aforementioned output points while no difference of the arithmetic elements is detected.

The logic diagram comparing part 8 extracts two types of information about differences (here, information about differences in control logic and signal name) between the two logic diagrams LG1 and LG3 in step S204 based on a result of the comparison of the arithmetic elements.

As for the information about a difference in control logic that is one of the two types of information about differences, the logic diagram comparing part 8 searches for an arithmetic element except those correlated in step S203 as information about a difference in control logic. As a result of the search for an arithmetic element in the two logic diagrams LG1 and LG3 except those detected in step S203 by the logic diagram comparing part 8, it is determined that an input point 60 (“01D”) in the logic diagram LG1 (FIG. 5), and input points 100 (“01D”), 120 (“01K”), a NOT element 121, and a logical AND element 122 in combination in the logic diagram LG3 (FIG. 11) corresponding to the input point 60 (“01D”), are different from each other. It is also determined that the logic diagram LG3 (FIG. 11) additionally includes an output point 123 (“02H”). Information indicating these determinations is detected as the information about a difference in control logic.

As for the information about a difference in signal name that is the other of the two types of information about differences, the logic diagram comparing part 8 searches for information about a difference between the signal names of the arithmetic elements correlated in step S203. As a result of the search for the information about a difference in signal name between the logic diagrams LG1 and LG3 shown in FIGS. 5 and 11 respectively by the logic diagram comparing part 8, the signal names “01A,” “01B,” “01C,” “01E,” “01F,” and “01G” in the logic diagram LG1, and the signal names “02A,” “02B,” “02C,” “02E,” “02F,” and “02G” in the logic diagram LG3 are detected as the information about a difference in signal name.

In step S205, the test table analyzing part 10 retrieves the test table TB1 (FIG. 6) about the similar unit “V-004” specified by the similar unit searching section 13 from the input test table storage 9.

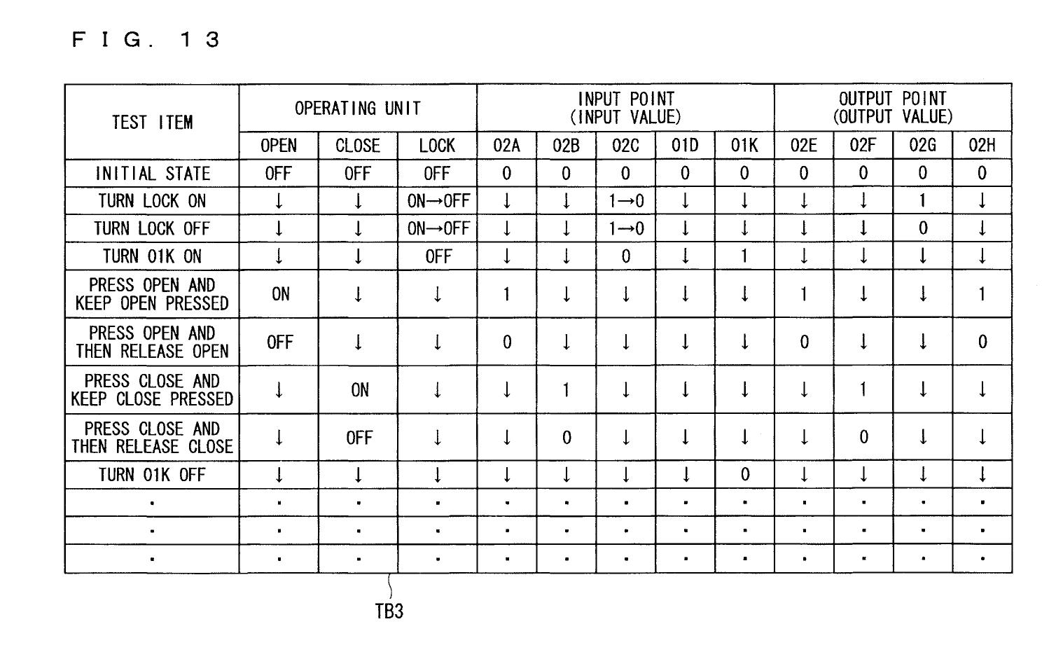

FIG. 13 shows a test table TB3 about the target unit “V-005” generated after the test table difference reflecting part 11 performs steps S206 and S207.

In step S206, the test table difference reflecting part 11 causes the information about a difference (information about a difference in signal name) detected in step S204 to be reflected in the test table TB1 retrieved by the test table analyzing part 10. More specifically, the test table difference reflecting part 11 makes the signal names “02A,” “02B,” “02C,” “02E,” “02F,” and “02G” take the place of the signal names “01A,” “01B,” “01C,” “01E,” “01F,” and “01G” in the retrieved logic diagram LG1 respectively.

In step S207, the test table difference reflecting part 11 causes the information about a difference (information about a difference in control logic) detected in step S204 to be reflected in the test table TB1 with their signal names changed.

More specifically, there is a correspondence between the input point 60 (“01 D”) in the logic diagram LG1, and the input points 100 (“01D”), 120 (“01K”), the NOT element 121, and the logical AND element 122 in combination in the logic diagram LG3. So, the test table difference reflecting part 11 adds a column of “01K” to the section “INPUT POINT” in the test table with their signal names changed. If the setting value of the input point 60 “O1D” was “0,” the test table difference reflecting part 11 defines the setting value of the input point 100 “O1D” to be “0,” and defines the setting value of the input point 120 “01K” to be “0” in this test table. If the setting value of the input point 60 “O1D” was “1,” the test table difference reflecting part 11 defines the setting value of the input point 100 “O1D” to be “0,” and defines the setting value of the input point 120 “01K” to be “1” in this test table.

The test table difference reflecting part 11 also causes the aforementioned information about a difference to be reflected in “TEST ITEMS” in the test table. More specifically, the test table difference reflecting part 11 changes the fourth row from “TURN O1D ON” to “TURN 01K ON,” and changes the ninth row from “TURN O1D OFF” to “TURN 01K OFF” in the test table incorporating the changes described above. The test table difference reflecting part 11 further adds a column of “01H” to the section “OUTPUT POINT” in the test table incorporating all the changes described so far, and copies confirmed values in the column of the output point 109 (“02E”) directly to the added column.

As a result, the test table difference reflecting part 11 generates the test table TB3 about the target unit “V-005.” Then, the test table difference reflecting part 11 stores the generated test table TB2 into the output test table storage 12.

### Third Preferred Embodiment

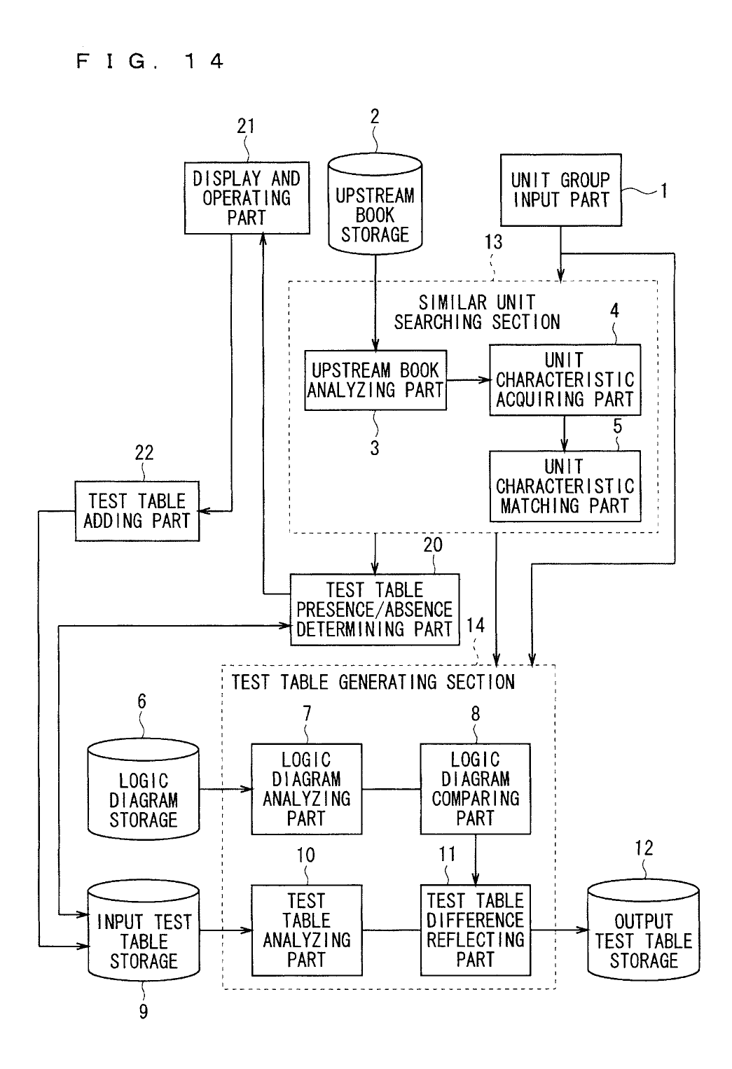

FIG. 14 shows the structure of a test table generating device of a third preferred embodiment of the present invention. Constituent elements of the third preferred embodiment such as those of the test table generating device that are also used in the first preferred embodiment are identified by the same reference numerals. In the below, attention is focused mainly on constituent parts except for these similar constituent elements. As shown in FIG. 14, the test table generating device of the third preferred embodiment is formed by adding a test table presence/absence determining part 20, a display and operating part 21, and a test table adding part 22. The display and operating part 21 functions as a display part on which characters and images are presented to the outside. The display and operating part 21 also functions as an operating part that accepts an operation to enter a new test table. As an example, a touch panel may be used as the display and operating part 21.

The operation of the third preferred embodiment is the same as that of the first preferred embodiment in that both designate a target unit with the unit group input part 1, and thereafter specify a similar unit with the similar unit searching section 13. The test table presence/absence determining part 20 determines if a test table about the similar unit specified by the similar unit searching section 13 is stored in the input test table storage 9. That is, the test table presence/absence determining part 20 determines if a test table about the similar unit specified by the unit characteristic matching part 5 is one of multiple predetermined test tables.

If the test table presence/absence determining part 20 determines that there is a test table about the similar unit, the test table generating device (test table generating section 14) thereafter operates in the same manner as it does in the first preferred embodiment to generate a test table.

If the test table presence/absence determining part 20 determines that there is no test table about the similar unit, the display and operating part 21 displays a notification indicating that there is no test table about the similar unit. In this case, namely if a test table about the similar unit does not exist in the input test table storage 9, a test table about the target unit cannot be generated automatically, and is created manually accordingly.

An operation is made through the display and operating part 21 after the test table about the target unit is newly created by an external operation, so the test table adding part 22 is instructed to enter the test table. A test table created by an external operation may also be called “created test table.” In response to the instructions given through the display and operating part 21 to enter the created test table, the test table adding part 22 enters the created test table into the input test table storage 9 so the created test table becomes one of multiple predetermined test tables.

In the aforementioned test table generating device of the third preferred embodiment, a created test table is added if the test table generating device does not have a test table about a similar unit. So, the created test table thereby added is used as a test table about the similar unit. This increases the types of test tables of similar units, thereby increasing the possibility of generation of a test table to be generated thereafter.

While the invention has been shown and described in detail, the foregoing description is in all aspects illustrative and not restrictive. It is therefore understood that numerous modifications and variations can be devised without departing from the scope of the invention.

What is claimed is:

1. A test table generating device for generating a test table showing a correlation between an input value and an output value, and which is used to determine the acceptance or rejection of a logic diagram when the logic diagram representing the substance of supervisory control of each of units in a supervisory control system is tested, the test table generating device comprising:
a unit group input part for designating a target unit to be targeted for generation of a test table, the designated target unit being one of said units;
an upstream book analyzing part for retrieving an upstream book about said target unit from an upstream book containing information about said units, and analyzing the retrieved upstream book;
a unit characteristic acquiring part for acquiring the unit characteristics of said target unit based on a result of the analysis made by said upstream book analyzing part;
a unit characteristic matching part for performing matching of the unit characteristics of said target unit acquired by said unit characteristic acquiring part, and specifying a similar unit having the same unit characteristics as those of said target unit; and
a test table generating section for acquiring a test table about said similar unit, and generating said test table about said target unit based on the acquired test table.

2. The test table generating device according to claim 1, wherein said test table generating section includes:
a logic diagram analyzing part for retrieving a logic diagram about said similar unit and a logic diagram about said target unit from logic diagrams about said units, and analyzing the retrieved logic diagrams;
a logic diagram comparing part for extracting information about a difference between said logic diagram about said similar unit and said logic diagram about said target unit based on results of the analyses made by said logic diagram analyzing part;
a test table analyzing part for retrieving said test table about said similar unit specified by said unit characteristic matching part from multiple predetermined test tables each of which is said test table; and
a test table difference reflecting part for generating said test table about said target unit by causing said information about a difference to be reflected in said test table retrieved by said test table analyzing part.

3. The test table generating device according to claim 2, wherein
said logic diagram analyzing part makes a correlation between input and output points of said similar unit represented in said logic diagram about said similar unit, and input and output points of said target unit represented in said logic diagram about said target unit; and
said logic diagram comparing parts compares said logic diagrams about said similar unit and said target unit by tracing their signal lines from one of the correlated input and output points to the other of the correlated input and output points, thereby extracting said information about a difference.

4. The test table generating device according to claim 1, further comprising:
a test table presence/absence determining part for determining if said test table about said similar unit specified by said unit characteristic matching part is one of multiple predetermined test tables each of which is said test table; and
a test table adding part for adding a created test table created by an external operation to become one of said multiple predetermined test tables, wherein
if said test table presence/absence determining part determines that there is no test table about said similar unit, said test table adding part adds said created test table to said multiple predetermined test tables.

5. The test table generating device according to claim 1, wherein
said upstream book contains a systematic diagram that shows interconnections between said units in said supervisory control system, and
said upstream book analyzing part analyzes said systematic diagram.

6. The test table generating device according to claim 1, wherein
said upstream book contains unit types indicating the types of said units in said supervisory control system, and control types indicating ways to control said units in said supervisory control system, and
said upstream book analyzing part analyzes said unit types and said control types.

7. A method of generating a test table showing a correlation between an input value and an output value, and which is used to determine the acceptance or rejection of a logic diagram when the logic diagram representing the substance of supervisory control of each of units in a supervisory control system is tested, the method comprising the steps of:
(a) designating a target unit to be targeted for generation of a test table, the designated target unit being one of said units;
(b) retrieving an upstream book about said target unit from an upstream book containing information about said units, and analyzing the retrieved upstream book;
(c) acquiring the unit characteristics of said target unit based on a result of the analysis made in said step (b);
(d) performing matching of the unit characteristics of said target unit acquired in said step (c), and specifying a similar unit having the same unit characteristics as those of said target unit; and
(e) acquiring a test table about said similar unit, and generating said test table about said target unit based on the acquired test table.
